(19) United States
(12) Patent Application Publication
(10) Pub. No.: US 2005/0273310 A1
(43) Pub. Date: Dec. 8, 2005

(54) Enhancements to performance monitoring architecture for critical path-based analysis

(76) Inventor: Chris J. Newburn, South Beloit, IL (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/143,425

(22) Filed: Jun. 1, 2005

Related U.S. Application Data
(60) Provisional application No. 60/577,317, filed on Jun. 3, 2004.

(51) Int. Cl. G06F 17/50

(52) U.S. Cl. 703/17; 712/17

(57) ABSTRACT

A method and apparatus is described herein for monitoring the performance of a microarchitecture and tuning the microarchitecture based on the monitored performance. Performance is monitored through simulation, analytical reasoning, retirement pushout measure, overall execution time, and other methods of determining per instance event costs. Based on the per instance event costs, the microarchitecture and/or the executing software is tuned to enhance performance.

### REFERENCE TO RELATED APPLICATION

This application claims the benefit of U.S. Provisional Application No. 60/577,317 entitled ” Enhanced Performance Monitoring Microarchitecture,” filed Jun. 3, 2004.

### FIELD

This invention relates to the field of computer systems, and in particular to performance monitoring and tuning of microarchitectures.

### BACKGROUND

Performance analysis is the foundation for characterizing, debugging, and tuning a microarchitectural design, finding and fixing performance bottlenecks in hardware and software, as well as locating avoidable performance issues. As the computer industry progresses, the ability to analyze the performance of a microarchitecture and make changes to the microarchitecture based on that analysis becomes more complex and important.

In addition to providing the best platform possible, the best performance is often achieved by tuning the application to run its best on that platform. There is a significant investment in identifying performance bottlenecks, figuring out how to avoid them through better code generation, and confirming the performance improvements. Performance monitors are a key element in that analysis. Performance monitoring provides a larger volume of performance data than pre-silicon simulations, and has been used to tweak microarchitectural designs to improve performance in areas such as store forwarding. Knowing just how often a performance issue arises and how much gain would be obtained from improving that part of the microarchitecture is essential in motivating silicon changes.

In the past, performance monitoring of serial execution machines has been relatively straight forward, as tracking serial performance bottlenecks are much easier then detecting performance limitations during parallel, out-of-order execution. Typical performance analysis decomposes the CPI (clocks per instruction) of the workload into individual components as follows: 1) count performance events in hardware, 2) estimate the relative contribution of each event to the program's critical path, and 3) combine individual components that contribute to the performance bottlenecks of the workload into an overall breakdown. Estimating per-instance costs for a single microarchitectural cause is difficult for an out of order, highly-speculative machine, where there is enough superscalar and pipeline parallelism to cover a significant fraction of many stall costs. To date, ad hoc methods have been used to estimate the per-instance impact of events, and the accuracy and variation of those estimates was often unknown.

For example, FIG. 1 illustrates an example of the fetch, execute and retirement of instructions 101-107 in a single-issue machine. Instruction 102 has branch misprediction 110, which delays the fetch of instruction 103, and pushes out the retiremnet of instruction 103 significantly after instruction 102. Instruction 104 has first-level cache miss 120, which further pushes out the retirement of instruction 105. But instruction 104's retirement pushout 125 is dwarfed by instruction 105's second level cache miss 130, which has such a long latentcy that branch misprediction 135 in instruction 106 does not have any impact on its retirement time. As enumerated by FIG. 1, there are intricate complexities in measureing retirement pushout, even in a single issue machine, let alone comprehensive performance monitoring in a processor that is capable of out-of-order highly speculative parallel execution.

### BRIEF DESCRIPTION OF THE DRAWINGS

The present invention is illustrated by way of example and not intended to be limited by the figures of the accompanying drawings.

FIG. 1 illustrates an embodiment of fetch, execute, and retirement for a plurality of operations in a single issue machine.

FIG. 2 illustrates an embodiment of a processor including a first performance monitoring module and a second microarchitectural tuning module.

FIG. 3 illustrates a specific embodiment of FIG. 2.

FIG. 4 illustrates an embodiment of a processor including a module to statically or dynamically re-compile the software.

FIG. 5 illustrates an embodiment of a system including a processor having a module for monitoring performance and tuning the microarchitecture of the processor.

FIG. 6a illustrates an embodiment of a flow diagram for monitoring performance and tuning a microprocessor based on the performance.

FIG. 6b illustrates a specific embodiment of FIG. 6a.

FIG. 6c illustrates another embodiment for monitoring performance and tuning a microprocessor.

FIG. 7 illustrates an embodiment for measuring retirement pushout upon occurence of a particular event.

### DETAILED DESCRIPTION

In the following description, numerous specific details are set forth such as specific architectures, features within those architectures, tuning mechanisms, and system configurations in order to provide a thorough understanding of the present invention. It will be apparent, however, to one skilled in the art that these specific details need not be employed to practice the present invention. In other instances, well known components or methods, such well-known logic designs, software compilers, software reconfiguration techniques, and processor defeaturing techniques, have not been described in detail in order to avoid unnecessarily obscuring the present invention.

Performance Monitoring

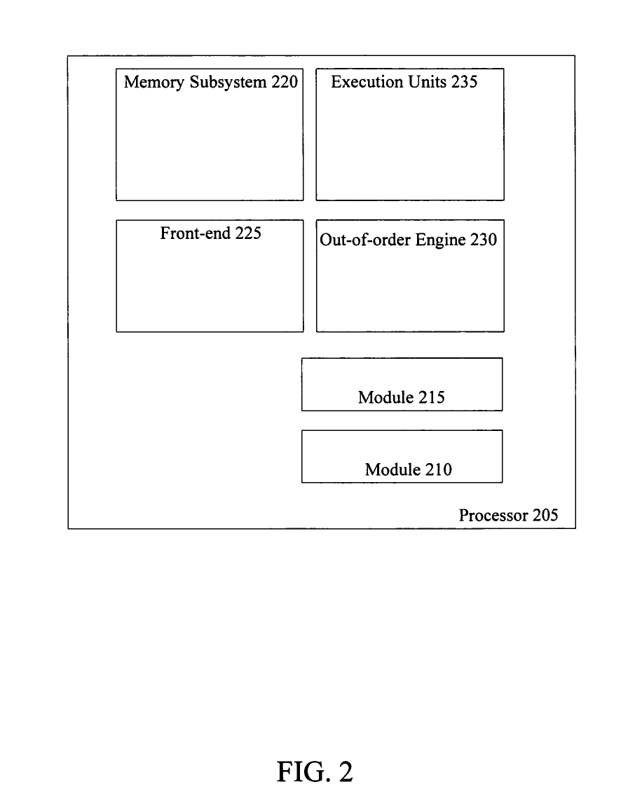

FIG. 2 illustrates an embodiment of a processor 205 having a performance monitoring module 210 and a tuning module 215. Processor 205 may be any element for executing code and/or operating on data. As a specific example, processor 205 is capable of parallel execution. In another embodiment, processor 205 is capable of out-of-order execution. Processor 205 may also implement branch-predication and speculative execution, as well as other known processing units and methods.

Other processing units illustrated in processor 250 include: memory subsystem 220, front-end 225, out-of-order engine 230, and execution units 235. Each of these modules, units, or functional blocks may provide the aforementioned functionality for processor 205. In an embodiment, memory subsystem includes a higher level cache and bus interface for interfacing with external devices, front-end 225 includes speculation logic and fetch logic, out-of- order engine 230 includes scheduling logic to re-order instructions, and execution units 235 include floating-point and integer execution units that execute in serial and in parallel.

Module 210 and module 215 may be implemented in hardware, software, firmware, or any combination thereof. Commonly, module boundaries vary and functions are implemented together, as well as separately in different embodiments. In one example, performance monitoring and tuning are implemented in a single module. In the embodiment depicted in FIG. 2, module 210 and module 215 are shown separately; however, module 210 and module 215 may be software executed by the other illustrated units 220-235.

Module 210 is to monitor the performance of processor 205. In one embodiment, performance monitoring is done by determining and/or deriving per-instance event costs to a critical path. A critical path includes any path or sequence of occurrences, tasks, and/or events that would contribute to the time it takes to complete an operation, instruction, group of instructions, or a program if the latency of any such occurrence, task or event were to be increased. Graphically, a critical path may sometimes be referred to as a path through a graph of data, control, and resource dependences in a program running on a particular machine for which the lengthening of any arc in that dependency graph would lead to an increase in the execution latency of that program.

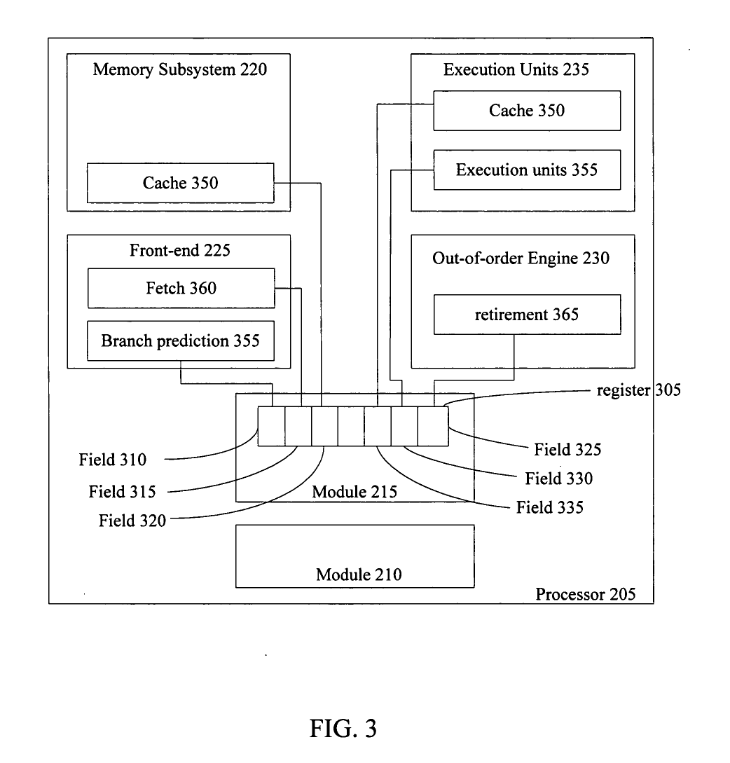

Therefore the per instance contribution of an event/feature to a critical path is, in other words, the contribution of events, such as a second level cache miss, or a microarchitectural feature, such as a branch prediction unit, to the latency experienced in completion of a task or a program. In fact, the contribution of an event or feature may vary significantly across application domains. Consequently, the event or microarchitectural feature cost/contribution may be determined for a specific user-level application, such as an operating system. Module 215 will be discussed in more detail in reference to FIG. 3.

An event includes any operation, occurrence, or action in a processor that introduces latency. A few examples of common events in a microprocessor include: a low-level cache miss, a secondary cache miss, a high-level cache miss, a cache access, a cache snoop, a branch misprediction, a fetch from memory, a lock at retirement, a hardware pre-fetch, a front-end store, a cache split, a store forwarding problem, a resource stall, a writeback, an instruction decode, an address translation, an access to a translation buffer, an integer operand execution, a floating point operand execution, a renaming of a register, a scheduling of an instruction, a register read, and a register write.

A microarchitectural feature includes logic, a functional unit, a resource, or other feature associated with an aforementioned event. Examples of microarchitectural features include: a cache, an instruction cache, a data cache, a branch target array, a virtual memory table, a register file, a translation table, a look-aside buffer, a branch prediction unit, a hardware prefetcher, an execution unit, an out-of-order engine, an allocator unit, register renaming logic, a bus interface unit, a fetch unit, a decode unit, an architectural state register, an execution unit, a floating-point execution unit, an integer execution unit, an ALU, and other common features of a microprocessor.

Clocks per Instruction

One of the primary indicators of performance is clocks per instruction (CPI). CPI may be broken down into several components, so that an indication of the fraction of cycles that may be attributed to each of several factors/events may be determined. These factors, as stated above may include events, such as latency introduced by missing caches and going to DRAM, branch misprediction penalties, pipeline delays incurred by at-retirement mechanisms, i.e. for locks, and so on. Other examples of factors include micro-architectural features that are associated with the events, such as a cache that is missed, a miss in a branch target array used for branch predication, the use of bus interfaces for going to DRAM, and the use of state machines for implementing locks.

Typically, the relative contribution of a factor is determined by multiplying the number of occurrences of the factor by its effect in cycles, then dividing by the total number of cycles. While such a breakdown may be precisely presented for a scalar, non-pipelined, non-speculative machine, it is difficult to give a precise cycle accounting for a superscalar, pipelined, out-of-order, and highly-speculative machine. Often there is enough parallelism in workloads that may be exploited by such a machine to hide at least a portion of the stall by doing useful work. As a result, the local impact of that stall may make a much smaller contribution to the overall critical path of the program than the theoretical per-instance cost. Surprisingly, the local stall may even have a positive impact on the overall execution time of the program, if that local delay leads to a better overall schedule.

Analyzing Per-Instance Contributions/Costs

Per instance event costs, i.e. an event's or microarchitectural features contribution to a critical path, may be determined in many different ways, including: (1) analytical estimates; (2) duration counts from performance monitors; (3) retirement pushouts as measured by hardware performance monitors and by simulators; and (4) changes in overall execution time due to changes in the number of events as measured by micro-benchmarks, simulations, and silicon defeatures.

Analytical Estimates

In a first embodiment, a per-instance cost, i.e. a contribution of a feature, is determined theoretically. Theoretical contribution may include empirical knowledge of operation of a feature or occurrence of an event, as well as simulation of an architecture. This is often derived from an understanding of the microarchitecture, and typically, focuses on the execution stage, rather than on retirement. The simplest form of analytical estimates characterize a local stall cost, independent of how those stalls may be covered through the parallelism available from performing other operations (stages of execution or instructions) in parallel.

Duration Counts

In another embodiment, a performance monitor determines contribution of a feature through duration counts. Some performance monitor events are defined to count each cycle that something of interest is happening. This yields a duration count instead of an instance count. Two such counts are the cycles that a state machine is active, e.g. page walk handler, lock state machine, and cycles that there's one or more entries in a queue, e.g. the bus's queue of outstanding cache misses. These examples measure time in an execution stage, and do not necessarily measure a retirement pushout, unless the execution is at retirement, which is the case for the lock state machine. This form of characterization is usable in the field to evaluate benchmark-specific costs.

Retirement Pushouts

Retirement pushouts are useful in determining contribution of events and features on a local scale, as well as extrapolating that measurement to a global scale. Retirement pushout occurs when one operation does not retire at an expected time or during an expected cycle. For example, for a sequential pair of instructions (or micro-ops), if the second instruction does not retire as soon as possible after the first (normally in the same cycle, or if retirement resources are constrained, the next cycle), then the retirement is considered to be pushed out. Retirement pushout provides a backward-looking, “regional” (rather than purely local) measurement of contribution to the critical path. It is backward looking in the sense that retirement pushout is cognizant of the overlap of all operations which were retired prior to some point in time. If two operations with a local stall cost of 50 begin one cycle apart, the retirement pushout for the second is at most one, rather than 50.

The actual measurement of retirement pushout may vary depending on when the pushout is measured from. In one instance, the measurement is from an occurrence of an event. In another embodiment, the measurement of pushout is from when the instruction or operation should have been retired. In yet another embodiment, retirement pushout is measured simply by counting the number of occurrences of retirement pushouts, as discussed below in reference to retirement pushout of sequential operations. There are various ways to measure/derive a per-instance contribution through retirement pushout. To illustrate, two methods of retirement pushout, sequential operations and tagging, are discussed below.

Both mechanisms enable the user to create a histogram of the distribution of retirement pushouts, by running repeatedly with different threshold values. Retirement pushout of sequential operations enables the creation of a profile of retirement delays for all operations in the program. Additionally, the tagging of retirement pushouts enables the creation of delay distribution profiles for individual/particular events, such as the individual contribution of branch mispredictions.

Retirement Pushout of Sequential Operations, i.e. Slow Retirement Qualification.

For this mechanism sequential operations instances are counted where the delay between retiring consecutive operations, or micro-operations, is greater than a user-specified threshold. Consequently, the pushout for consecutive operations is measured and the number of pushouts with a latency over a predefined threshold are reported.

In one embodiment, slow retirement qualification is measured using a special-purpose counter, which counts cycles in which instructions from a thread are not being retired. The counter is initialized to a user-defined value as soon as a first operation retires. If the counter underflows or overflows, depending on the design, for a particular second instruction, that second instruction is considered to have a slow retirement, i.e. a retirement pushout.

As an example of a design utilizing a down counter, if a user wants to count how many instruction retirements are pushed out over 25 cycles, then the counter is set to a predefined value of 25. If it underflows, the retirement of a second instruction is considered pushed out. In an up-counter implementation the user defined value may be initialized to either 0 or a negative number. For example, the counter is initialized to 0 and counts up to a threshold value of 25. If the counter overflows then there is a retirement pushout. In the alternative, the up-counter may be initialized to −25 and count up to 0, which simplifies the logic comparison when determining a counter overflow.

Retirement Pushout Tagging, i.e. Retirement Pushout Profiling

Very similar to slow retirement qualification, retirement pushout tagging qualifies instructions or operation which had retirement pushouts above some threshold. However, in this mechanism, slow retirement qualification is but one of many other qualifications on the instruction or operation of interest. Other qualifications may include particular events that occurred for that instruction or operation, such as a second-level cache miss. These qualifications are logically combined, and the instruction or operation is counted if it meets the specified qualification criteria. Note that qualifiers/events may be logically operated on or combined, which may be user definable in specified machine state registers.

In another embodiment, an operation is tagged based on exclusion of a specific event or events. As stated above parallel execution may mask the actual effect of a particular event. As a specific example, a miss to a third-level cache may dwarf the effect of a miss to the second level cache. To isolate the effect of a miss to a second level cache, a particular operation may be tagged, if it results in a miss to the second level cache and does not miss the third level cache. In other words, measurement of operations resulting in third level cache misses are excluded from measurement. Therefore, that tagging includes selecting an operation upon an occurrence of a particular event and the non-occurrence of at least a second event.

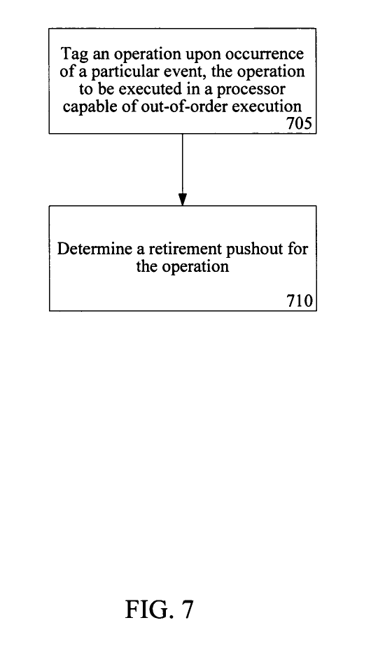

Turning briefly to FIG. 7, an embodiment for measuring retirement pushout using a tagging mechanism is illustrated. In flow 705, an operation is tagged, upon occurrence of a particular event and/or the exclusion of a particular event. The operation is to be executed in a processor capable of parallel execution. However, the processor may also be capable of serial execution, speculative execution, and out-of-order execution.

The particular event may be any event in a microprocessor as discussed above. In one embodiment, the event is a precise event based sampling (PEBS) at retirement event. In PEBS, an operation (micro-operation or instruction) is marked (tagged) as having experienced an event of interest, such as a cache miss. As that operation retires, the retirement logic notes that it is tagged and takes special actions. The address of the instruction and architectural state such as the flags and architectural registers are saved into a memory buffer. In this case, the pushout latency is recorded along with the other information. The program execution may continue following those special actions until the memory buffer in which such information is recorded is (nearly) full. When it is full (or above a user-specified watermark), a performance monitoring interrupt is caused, signaling that the user should read that memory buffer. The actions taken upon a PEBS may be managed by either a finite state machine in the hardware, through instruction in microcode, or a combination thereof.

A few specific examples of an event that results in tagging of an operation include: a cache miss, a cache access, a cache snoop, a branch misprediction, a lock upon retirement, a hardware pre-fetch, a load, a store, a writeback, and an access to a translation buffer. Tagging includes selecting an operation for measurement. Note that these events may also be targeted for exclusion, as the operation may not be tagged if one of these events also occur in conjunction with the particular event as discussed above.

After tagging or selecting an operation, in flow 710, a retirement pushout for the operation is determined. As mentioned above, determining a retirement pushout may be the actual measurement of the delay in retirement, as well as simply counting the operation as one delayed retirement due to the particular event.

In the embodiment where the actual measurement of the retirement pushout is the goal, a threshold modulus in a counter, such as the counter used for the slow retirement qualification, is set to 0, so that the final value upon retirement is a positive number equal to the retirement pushout. In one instance, the first counter is initialized and the retirement pushout is determined based on the initialization of the first counter and use of a storage register. In this instance, the state of the first counter is copied into another machine state register. Upon retirement, the storage register is frozen and is not updated. Thus the storage register is stable until software reads it out.

Note that measuring of pushout has been referred to in reference to measurement at retirement. However, pushout may be measured at other in-order choke points in an out-of-order machine, such as fetch, decode, issue, allocation of memory operations into a memory-ordering buffer, and the global visibility of memory operations.

Overal Execution Time

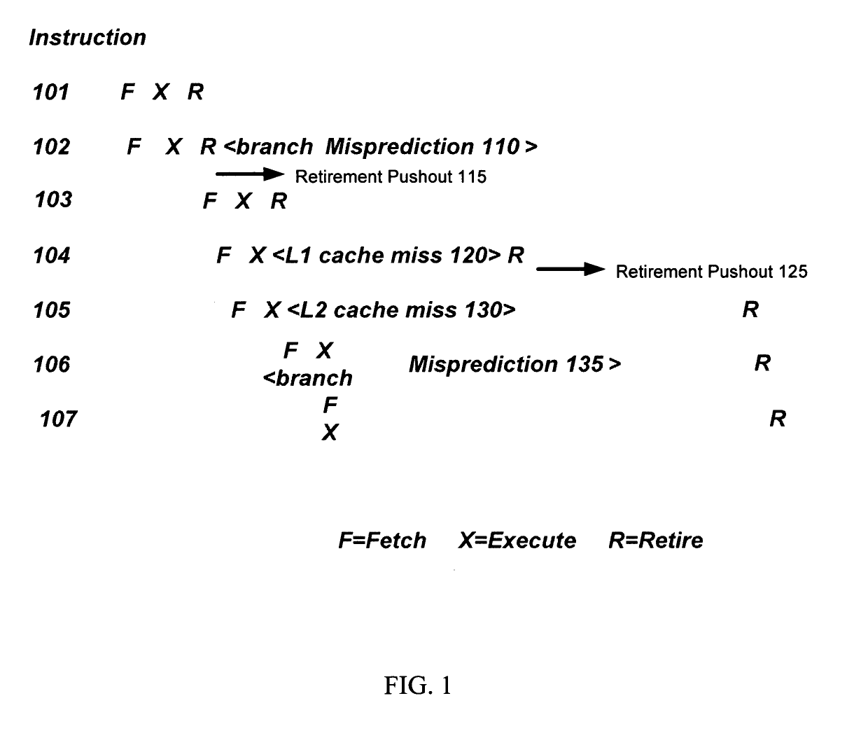

Local stall costs may be partially or fully covered by other work which is done in parallel. Retirement pushouts that capture regional delay may also be partially or fully covered by work, or other stalls, that are still underway at the time at which retirement pushout is measured. One way retirement pushout is covered is illustrated in FIG. 1, as discussed above. The ultimate measure of contribution that a given operation's stall makes to the critical path of a program is the change in execution latency that occurs due to that stall cause.

One indication of average incremental contribution to the global critical path is to measure the entire execution of a program or long trace, i.e. long trace execution monitoring. This approach covers contributions to the critical path that occur anywhere in the pipeline, and take into account the fact that local delays may be covered by other parallelism. The incremental contribution is derived by changing the number of instances of an event, which changes the execution time, and computing the change in execution time divided by the change in the number of events. For example, if increasing the cache size drops the number of cache misses from 100 to 90, and drops the execution time from 2000 to 1600, then the incremental contribution is (2000-1600)/(100-90)=40 cycles per miss.

Implementing this technique may be done in a plurality of ways. First, two versions of a micro-benchmark may be constructed, one with events and the other without. Second, a simulator configuration may be changed to introduce or eliminate events. The simulation is run for one or more programs in both configurations, and both the number of events and the total execution time is recorded for each case. Finally, some products support silicon defeatures, such as shrinking the size of a branch target array or changing the policies. This may be used to affect branch prediction rates, for example.

As mentioned above, determining a contribution of a microarchitectural feature, i.e. an event cost, may be done through (1) analytical estimates; (2) duration counts from performance monitors; (3) retirement pushouts as measured by hardware performance monitors and by simulators; and (4) overall execution time as measured by micro-benchmarks, simulations, and silicon defeatures. However, performance monitoring and determination of contribution to a critical path is not limited to an orthogonal implementation of one of the aforementioned methods, but rather any combination may be used to analyze the contribution of an event of a silicon feature to the critical path.

An Example of Per Instance Cost for Particular Events

To evaluate the per-instance cost of the various events, the techniques described in the analyzing per-instance contributions section were employed. There are, of course, numerous contributors to the comprehensive CPI breakdown of a trace. Four significant contributors were chosen to demonstrate the effectiveness of each described technique. For each event, however, it is not always possible or convenient to use all of the techniques. For example, performance monitoring duration counts might not be available for the event under consideration. Likewise, perturbing execution by adjusting a size or policy in the simulator might not affect the number of occurrences of an event or change the run time in a particular trace. Table 1 shows the summary of the estimated costs for each of these four causes based on perturbation of simulated execution, and provides an indication of variance in impact that is based on overall simulation results.

TABLE 1
Empirical per instance costs

| | Value | Std | Within | |
|---|---|---|---|---|
| Stall Cause | (median) | Dev | 1 σ | Measurement Method |
| Branch | 25 | 35 | 85% | Disabled the indirect |
| Mispredicts | | | | branch predictor |
| L1 Data Cache | 9 | 6 | 92% | Doubled the L1 cache size |
| Miss | | | | |
| L2 Data Cache | 257 | 158 | 74% | Doubled the L2 cache size |
| Miss | | | | |

Branch Mispredictions

Branch mispredictions are a common cause of application slow down. They force the restart of processor pipeline and throw away speculative work. Branch predictors have become more and more accurate over time. Nevertheless, with deeper and wider pipelines, mispredictions may cause considerable loss of opportunity to complete useful work.

TABLE 2
Branch misprediction per instance event cost

| | Sim | | | |
|---|---|---|---|---|
| Analytical | exec | HW ret pushout | Sim ret pushout | Microbench |
| 31 | 25 | Spikes at 36, 41, 47 | 36 | 34 |

The analytical measure of branch misprediction cost is the number of cycles of delay (31) from where a branch misprediction is normally detected, at execution, back to where instructions are normally fetched, from the trace cache. The analytical perspective measures the real delay incurred in the front end of the machine. This delay may be increased if there is any delay in evaluating the branch condition, either due to resource contention, or because of an unresolved data dependence, especially if the dependence is on a load that suffered a cache miss. It's for these reasons that the retirement pushout delay may be in the mid-thirties into the forties, as seen in the microbenchmarks, the HW retirement pushouts, and the simulated retirement pushouts. Three values are shown for the HW retirement pushouts in Table 2. The micro-benchmark used here had a loop body with a conditional branch and no memory references. 28% more branches had a delay of 36 than at 35, 27% more branches had a delay of 40 vs. 39, and 43% more branches had a delay of 41 vs. 40 cycles. The microbenchmarks closely match the analytical model since they contain little parallel work and don't require complex cleanup.

However, as shown in FIG. 1, where instruction 106 has a branch misprediction, a delay in the front end may have no impact if there has been an earlier retirement pushout in the back end of the machine. Also, a later cache miss may drown out the branch's contribution to the critical path with a much larger delay. This is one reason that the average contribution to overall critical path is much lower than the retirement pushout. The simulated overall contribution to the critical path was derived from disabling the indirect branch predictor, so that it may then only predict the last target. Furthermore, in real applications, the off-path code may often perform useful data prefetches and DTLB lookups which lessen the impact of the mispredictions. Finally, overlapping the processing of one misprediction with the processing of a second may reduce the average contribution to overall critical path.

From this discussion, it is clear that the actual average contribution to critical path may be highly dependent on the context, and retirement pushouts may overestimate the per-instance cost. A scaling factor, such as ˜70% may be applied to the HW-measured retirement pushouts to derive the median per-instance cost. Note that this event cost may be highly dependent on the specific microarchitecture and even implementation within the same microarchitectural family.

First Level (L1) Cache Miss

First level cache misses are a common occurrence. Out-of-order processors are designed to find independent work in the instruction stream to keep the processor busy while servicing the miss out to the second level cache. As a result, only a small fraction of the local L1 miss cost (e.g. retirement pushout) contributes to the overall critical path.

TABLE 3
First level cache miss per instance event cost

| Analytical | Sim exec | Sim ret pushout | Microbench |
|---|---|---|---|
| 18 | 9 | 18.3 | 26 |

The analytical model here describes the overhead of the L1 miss on top of the normal load-to-use cost. The microbenchmark for this event consists of a pointer-chasing loop which encounters a uniform distribution of 18 cycle overheads. A scaling factor of ˜50% may be applied to the hardware retirement pushout for all L1 miss events to arrive at the median per-instance cost.

Second Level (L2) Cache Miss

Second level cache misses may either be sent off to a higher level cache or to a memory controller/DRAM. Out-of-order processors are designed to find independent L2 cache misses to pipeline the processing of these long transactions.

TABLE 4
Second level cache miss per instance event cost

| Analytical | Sim exec | Sim ret pushout | Microbench |
|---|---|---|---|
| 306 | 256 | 281 | 300 |

The analytical measure of cache misses is 306 clocks with streaming DRAM page hits. This is computed from 90 ns DRAM with an 800 MHz FSB on a 3.4 GHz processor. The microbenchmark, which consists of simple pointer chasing code, correlates well with the analytical model. This kernel was designed to hit in the DTLB but not realize any benefit from the hardware prefetcher. This there is little parallel work to do that might hide some of the latency, and little independent work to do that would prevent each load from promptly being sent to the DRAM. The retirement pushouts and the simulated executions all result in a per instance cost that is less than the analytical value. In fact, the simulated executions show a wide variance in the per instance cost across the traces, both shorter and longer than the analytical value. Clearly, there is benefit from overlapped DRAM accesses on the short latency end of the spectrum. Longer per-instance latencies may occur in several ways, including processor memory request queue depth limitations and bus bandwidth shortfalls.

The hardware prefetcher plays a very important role in this latency. While appropriately throttle controlled, it has the ability to insert numerous requests into the memory system thereby increasing the latency of subsequent demand loads. On the other end of the spectrum, the prefetcher sometimes begins a prefetch too late to avoid the miss on a younger load, but early enough to have caused the data to be on its way from DRAM at the time of the younger load. This results in shorter per instance effective miss costs. In general, the median per instance cost is very similar to HW retirement pushout measurement.

Variation of costs vary significantly across application domains, as suggested above. Therefore, potentially having an in-field mechanism for measuring cost for a given application may be extremely helpful in determining contribution of specific features. In light of this variation, a microarchitecture may be tuned on a per-application basis.

Tuning the Microarchitecture

The microarchitecture may be tuned, such as during the retirement pushout measurement and overall execution time measurement to determine per instance event cost. However, the microarchitecture may also be tuned in response to the per instance event cost. Tuning of a microarchitectural feature or a microarchitecture includes changing the size, enabling, or disabling of logic, a feature, and/or a unit within the microarchitecure, as well as changing policies within the microarchitecture.

In one embodiment, tuning is done based on a contribution, i.e. per instance contribution, of a microarchitectural feature. As a first example, the size of the feature is altered, the feature is enabled, the feature is disabled, or policies associated with the feature are altered based on which action reduces latency in a critical path. As another example, other considerations such as power may be used to tune the microarchitecture. In this example, it may be determined that disabling the feature increases latency by an insignificant amount. However, based on the determination that the performance benefit of the feature is insignificant and that disabling the feature would save significant power, the feature is tuned, e.g. disabled.

As an empirical example, it was noticed on previous architectures that in several macro workloads a significant number of aliasing conflicts were noticed. One of theses examples were aliasing conflicts occurred was between multiple threads accessing the same cache lines.

A software thread is at least a part of a program that is operable to be executed independently from another thread. Some microprocessor even support multi-threading in hardware, where the processor has at least a plurality of complete and independent sets of architecture state registers to independently schedule execution of multiple software threads. However, these hardware threads share some resources, such as caches. Previously, accesses to the same line in cache by multiple threads resulted in displacing of the cache line and the reduction of locality. Therefore, the starting address of data memory for the threads was set to different values to avoid the displacement of lines in cache between threads.

Turning to FIG. 3, a specific embodiment of module 215 in processor 205 is illustrated. Module 215 is to tune a microarchitectural feature for a user-level application, based on at least the contribution of the microarchitectural feature to the critical path.

A very specific example of this type of tuning includes, monitoring performance of a hardware pre-fetcher during applications, or phases of an application such as garbage collection. Garbage collection is run with the hardware prefetcher enabled, then disabled, and it is discovered that in some instances garbage collection performs better without the hardware prefetcher. Consequently, the microarchitecture may be tuned and the hardware prefetcher disabled upon execution of a garbage collection application.

Other examples of changing policies based on performance analysis include the aggressiveness of prefetching, the relative allocation of resources to different threads in a simultaneous threading machine, speculative page walks, speculative updates to TLBs, and the selection among predictive mechanisms for branches and memory dependences.

FIG. 3 illustrates microarchitectural features: memory subsystem 220, cache 350, front-end 225, branch prediction 355, fetch 360, execution units 235, cache 350, execution units 355, out-of-order engine 230, and retirement 365. Other Examples of microarchitectural features include: a cache, an instruction cache, a data cache, a branch target array, a virtual memory table, a register file, a translation table, a look-aside buffer, a branch prediction unit, an indirect branch predictor, a hardware prefetcher, an execution unit, an out-of-order engine, an allocator unit, register renaming logic, a bus interface unit, a fetch unit, a decode unit, an architectural state register, an execution unit, a floating-point execution unit, an integer execution unit, an ALU, and other common features of a microprocessor.

As mentioned above, tuning a microarchitectural feature may include enabling or disabling the microarchitectural feature. As in the example with the hardware prefetcher from above, the prefetcher may be disabled if the contribution is determined to be enhanced, i.e. better, when the feature is disabled during particular software programs.

One way of determining the contribution of a microarchitectural feature to a critical path for a user-level application is to execute the user-level application with the microarchitectural feature enabled. Then, execute the user-level application with the microarchitectural feature disabled. Finally, the contribution of the microarchitectural feature to the critical path for the user-level application is determined based on comparing the execution of the user-level application with the feature enabled to the execution of the user-level application with the feature disabled. Simply, from measuring the overall execution time each time the user-level application is executed, it is determined which overall execution time is better; the overall time with the feature enabled or disabled.

As a specific example, module 215 includes defeature register 305. Defeature register 305 includes a plurality of fields, such as fields 310-335. The fields may be individual bits, or each field may have a plurality of bits. Additionally, each field is operable to tune a microarchitectural feature. In other words, the field is associated with a microarchitectural feature, as field 310 is with branch predication 355, field 315 is with fetch 360, field 320 is to cache 350, field 325 is to retirement logic 365, field 330 is to execution unites 355, and field 335 is to cache 350. When one of the fields, such as field 310, is set, it disables branch predication 355.

Another module, such as a software program, associated with module 215, embedded in module 215, or part of module 215 may set a field, such as field 310, if the performance contribution of the feature to the critical path, when disabled, is enhanced as discussed above. As noted above, module 215 may be hardware, software, or a combination thereof, as well as associated with or partially overlapping module 210. For example, as part of the functionality of module 210, to determine a contribution of branch predication 355 during execution of a user-level program, register 305, illustrated in module 215, may be used to tune or disable features of processor 205, such as branch prediction 355.

In another embodiment, defeaturing, i.e. tuning, includes changing the size, either physically or virtually, of a feature. In the alternative to the example above, if the contribution of branch prediction 355 were show to enhance the execution of a user-level application, then the size of branch prediction 355 may be increased/decrease accordingly through field 310. The example below illustrates the ability to tune the processor both to discover contribution of a feature or event, such as a cache miss, by tuning the size of caches.

Tuning Software

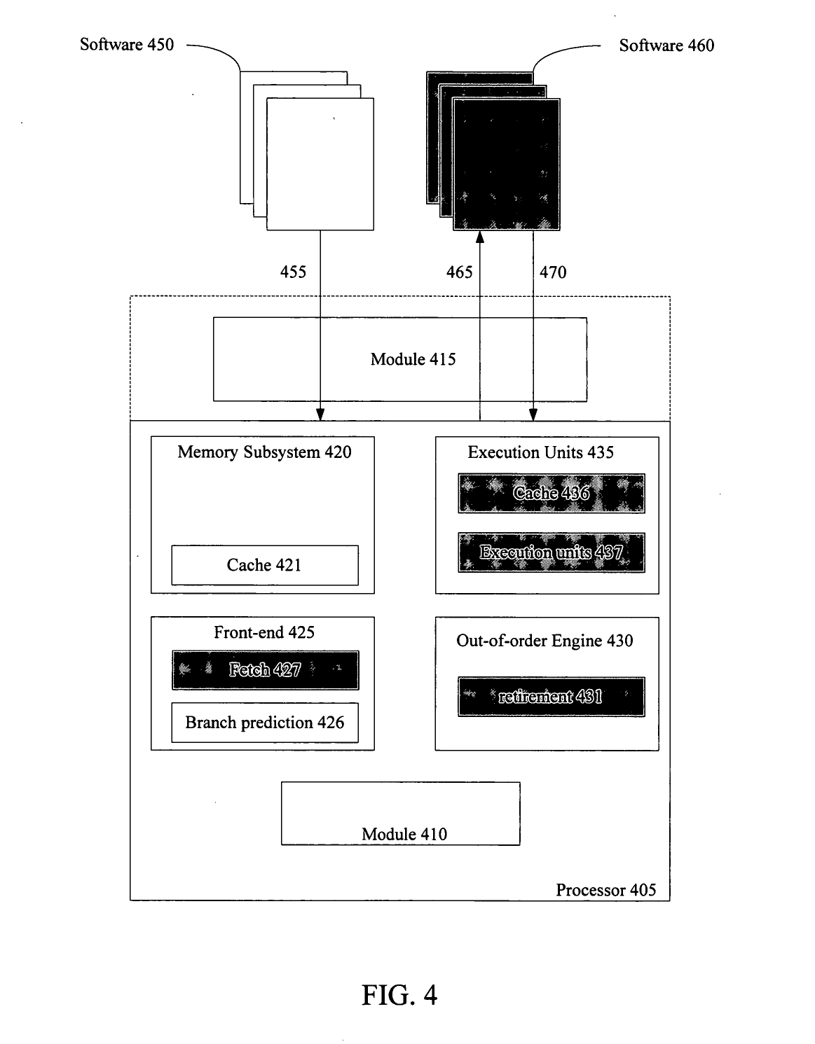

Turning to FIG. 4 an embodiment of a processor monitoring performance and tuning software is illustrated. Processor 405, much like processor 205 shown in FIGS. 2 and 3, may have any known logic associated with a processor. As illustrated, processor 405 includes units/features: memory subsystem 420, front-end 425, out-of-order engine 430, and execution units 435. Within each of these functional blocks numerous other microarchitectural features may exist, such as second level cache 421, fetch/decode unit 427, branch prediction 426, retirement 431, first level cache 436, and execution units 437.

As above, module 410 determines a per-instance event cost in a critical path for execution of a software program. Examples of deriving a per-instance event cost from above include duration counts, retirement pushout measurement, and long trace execution measurement. Note once again, that module 410 and module 415 may have blurred boundaries, as their functionality, hardware, software, or combination of hardware and software may overlap.

In contrast to FIG. 3, where module 415 tuned the microarchitecture by interfacing with the features, module 415 is to tune a software program based on the per instance event cost in the critical path. Module 415 may include any hardware, software, or combination for compiling and/or interpreting code to execute on processor 405. In one embodiment, module 415 recompiles code that is executed on a subsequent run of the program to utilize the aforementioned microarchitectural features more or less often as compared to originally compiled code based on a determined per instance event cost. In another embodiment, module 415 compiles code differently for the remainder of the same run of the program, i.e., dynamic compilation or recompilation is used to improve the execution time on a particular workload and platform.

As stated above, in addition to being able to tune the microarchitecture, better performance may be achieved by tuning the application to run its best on that platform. Tuning software includes optimizing code. One example of tuning an application is the recompilation of the software program. Tuning software may also include optimizing software/code to block data structures to fit within caches, re-laying out code to take advantage of default branch prediction conditions that don't require use of branch predictor table resources, emitting code at different instruction addresses so as to avoid certain aliasing and conflict conditions that can lead to problems with locality management in branch prediction and code caching structures, re-laying out data in dynamically-allocated memory or on the stack (including stack alignment) to avoid penalties incurred by spanning a cache line, and adjusting the granularity and alignment of accesses in order to avoid store forwarding problems.

As a specific example of tuning software, software 450 is executed with/on processor 405. Module 410 determines a per instance event cost, such as the cost of mispredicting a branch in branch prediction logic 426. Based on this analysis, module 415 re-lays out software 450 into software 460, which is the same user-level application re-laid out to execute differently on processor 405. In this example, software 460 is re-laid out to take better advantage of default branch prediction conditions. Therefore, software 460 is recompiled to utilize branch prediction 426 differently. Other examples may include executing instructions in code to disable branch prediction logic 426 and changing software hints used by branch prediction logic 426.

A System for Performance Monitoring

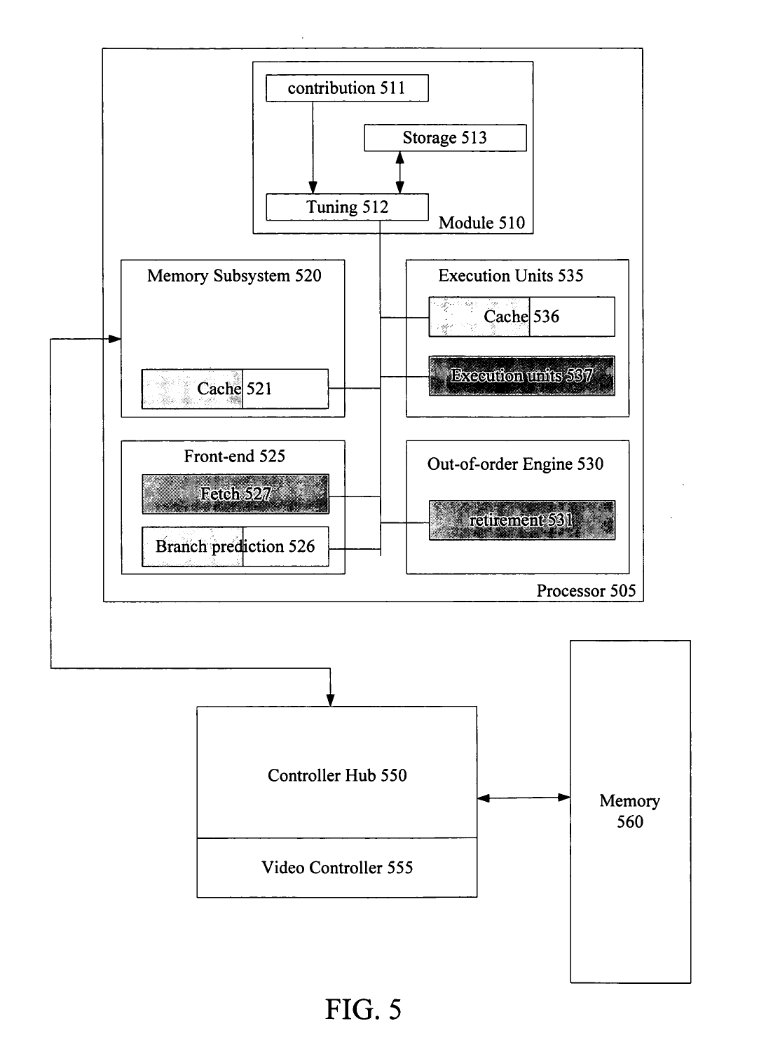

Referring next to FIG. 5, as system using performance monitoring is illustrated. Processor 505 is coupled to controller hub 550 and controller hub 550 is coupled to memory 560. Controller hub 550 may be a memory controller hub or other portion of a chipset device. In some instances, controller hub 550 has an integrated video controller, such as video controller 555. However, video controller 555 may also be on a graphics device coupled to controller hub 550. Note that other components, interconnects, devices, and circuits may be present between each of the devices shown.

Processor 505 includes module 510. Module 510 is to determine a per instance event contribution during execution of a software program, tune an architectural configuration of microprocessor 505 based on the per instance event contribution, store the architectural configuration, and re-tune the architectural configuration based on the stored architectural configuration, upon subsequent execution of the software program.

As a specific example, module 510, utilizing contribution module 511, determines an event contribution during execution of a software program, such as an operating system. Other examples of software programs include a guest application, an operating system application, a benchmark, a micro-benchmark, a driver, and an embedded application. For this example, assuming an event contribution, such as a miss to a first level cache 536 did not affect execution significantly, cache 536 may be reduced in size to save power without affecting execution time in the critical path. Therefore, tuning module 512 tunes the architecture of processor 505 by reducing first level cache 536 in size. The tuning may be done, as mentioned above, with a register having fields associated with different features in processor 505. Where a register is used, storing the architectural configuration includes storing the register values in storage 513, which is simply another register or memory device, such as memory 560. Upon subsequent execution of the software program, the performance monitoring step does not have to be repeated, and the previous stored configuration may be loaded. Consequently, the architecture is re-tuned for the software program based on the stored configuration.

A Method for Performance Monitoring

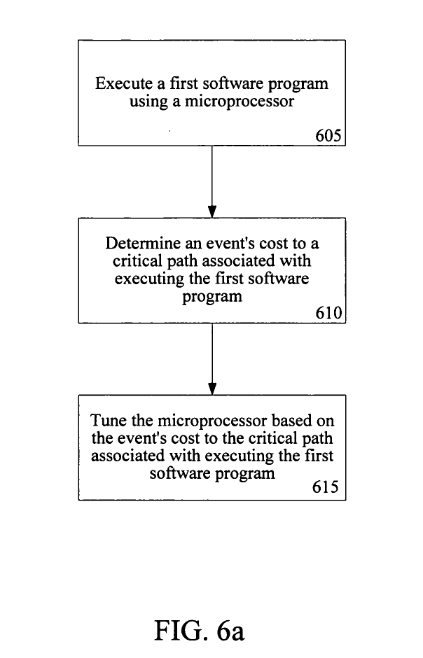

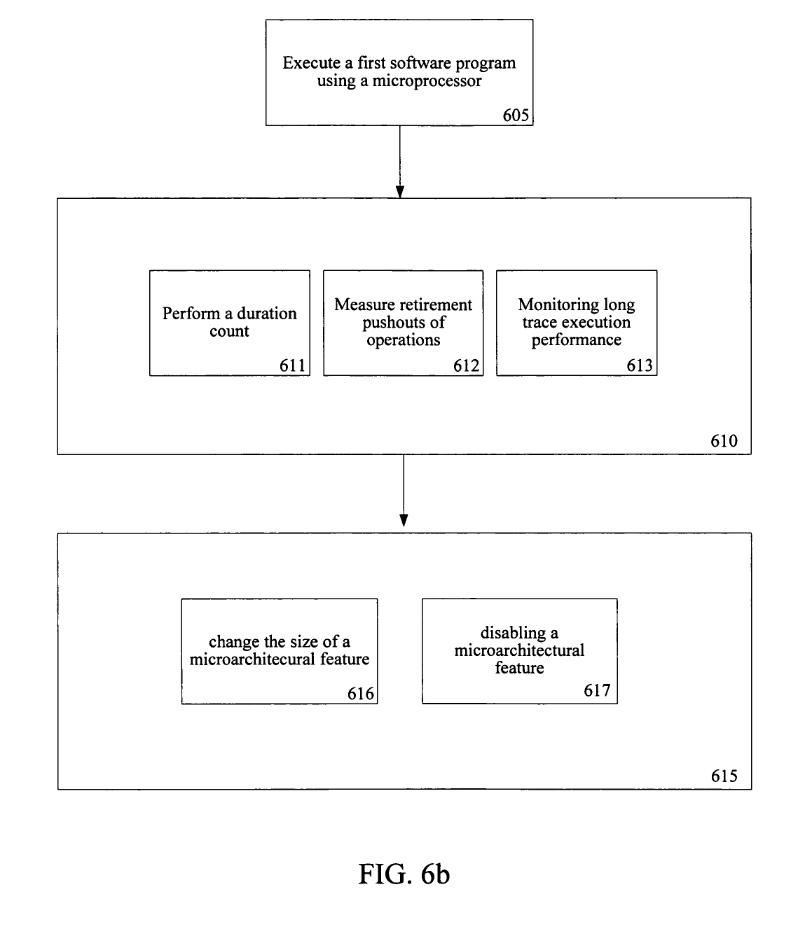

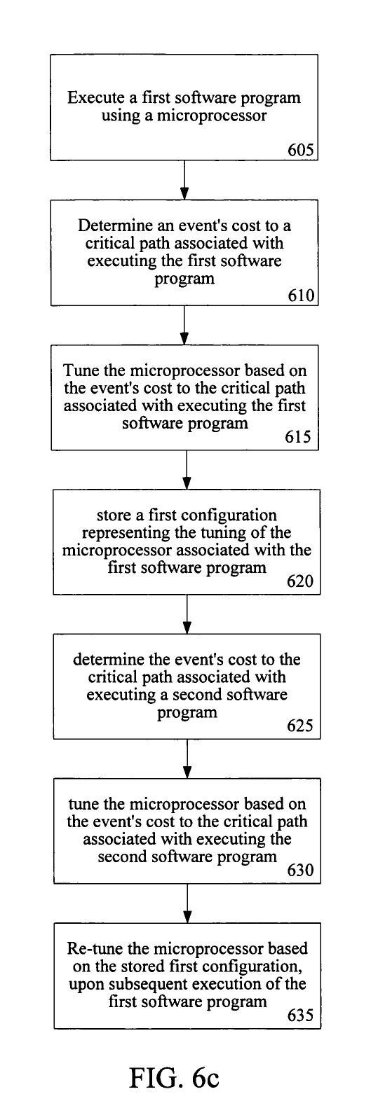

FIG. 6a illustrates an embodiment of a flow diagram for monitoring performance and tuning a microprocessor. In flow 605 a first software program is executed using a microprocessor. In one embodiment, the microprocessor is capable of out-of-order parallel execution. Next, in flow 610, an event's cost to a critical path associated with the executing of the first software program is determined.

Turning to FIG. 6b examples of determining an event's cost and tuning the microprocessor are illustrated. An event cost may be determined by analytical analysis, duration counts, as shown in flow 611, retirement pushouts, as in flow 612, and/or overall execution time, as shown in flow 613. Note that any combination of these methods may be used to determine an event's cost.

A few examples of common events in a microprocessor include: a low-level cache miss, a secondary cache miss, a high-level cache miss, a cache access, a cache snoop, a branch misprediction, a fetch from memory, a lock at retirement, a hardware pre-fetch, a load, a store, a writeback, an instruction decode, an address translation, an access to a translation buffer, an integer operand execution, a floating point operand execution, a renaming of a register, a scheduling of an instruction, a register read, and a register write.

Returning to FIG. 6a, in flow 615, the microprocessor is tuned based on the event's cost to the critical path associated with executing the first software program. Tuning includes any change to the microarchitecture to enhance performance and/or execution time. Referring back to FIG. 6b, one example of tuning includes enabling or disabling a microarchitectural feature, as in flow 617. A few illustrative examples of features include, a cache, a translation table, a translation look-aside buffer (TLB), a branch prediction unit, a hardware prefetcher, an execution unit, and an out-of-order engine. Another example includes changing the size or frequency of use of a microarchitectural feature, as in flow 616. In yet another embodiment, tuning the microprocessor includes tuning/compiling the software program to be executed to utilize the processor differently, such as not utilizing a hardware prefetcher.

As of yet, performance monitoring and tuning has been discussed in reference to a single software program to describe performance monitoring. However, performance monitoring and tuning may be implemented with any number of applications to be executed on a processor. FIG. 6c illustrates an embodiment of a flow diagram for profiling/tuning an architecture for a second program and upon loading the first application again, the microprocessor is retuned.

Flow 605-615 are the same as shown in FIG. 6a. In flow 620 the first configuration representing the tuning of the microprocessor associated with the first software program is stored. An event's cost to the critical path associated with executing a second software program is determined in flow 625. In flow 630, the microprocessor is tuned based on the event's cost to the critical path associated with executing the second software program. Finally, the microprocessor is re-tuned based on the stored first configuration upon subsequent execution of the first software program on flow 635.

As can be seen from above a microprocessor is dynamically tuned based on the performance of individual applications. As certain features in a processor are utilized differently, and the cost of events, such as a cache miss, vary significantly from application to application, the microarchitecture and/or software applications themselves may be tuned to execute more efficiently and quickly. The cost of events and contributions of features are measured through any combination of analytical methods, simulation, measurement of retirement pushouts, and overall execution time to ensure the correct performance is being monitored, especially for parallel execution machines.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative sense rather than a restrictive sense.

1. A method comprising:
executing a first software program using a microprocessor;
determining an event's cost to a critical path associated with executing the first software program; and
tuning the microprocessor based on the event's cost to the critical path associated with executing the first software program.

2. The method of claim 1, wherein the microprocessor is capable of out-of-order parallel execution.

3. The method of claim 1, wherein tuning the microprocessor comprises changing the size of a microarchitectural feature, the microarchitectural feature being selected from a group consisting of an instruction cache, a data cache, a branch target array, a virtual memory table, and a register file.

4. The method of claim 1, wherein tuning the microprocessor comprises disabling a microarchitectural feature, the microarchitectural feature being selected from a group consisting of a cache, a translation table, a look-aside buffer, a branch prediction unit, a hardware prefetcher, and an execution unit.

5. The method of claim 1, further comprising:
storing a first configuration representing the tuning of the microprocessor associated with the first software program;
determining the event's cost to the critical path associated with executing a second software program;
tuning the microprocessor based on the event's cost to the critical path associated with executing the second software program; and
re-tuning the microprocessor based on the stored first configuration, upon subsequent execution of the first software program.

6. The method of claim 5, wherein each of the first and second software programs are selected from a group consisting of a guest application, an operating system, an operating system application, a benchmark application, a driver, and an embedded application.

7. The method of claim 1, wherein the determining an event's cost to a critical path comprises performing a duration count.

8. The method of claim 7, wherein the performing a duration count comprises counting cycles that a state machine in the microprocessor is active, wherein the state machine is selected from a group consisting of a page walk handler, a lock state machine, and a bus' queue of outstanding cache misses.

9. The method of claim 1, wherein the determining an event's to a critical path comprises measuring retirement pushouts of operations.

10. The method of claim 9, wherein the measuring retirement pushouts of operations comprises measuring a delay in retirement of a sequential pair of operations.

11. The method of claim 9, wherein the measuring retirement pushouts of operations comprises measuring a retirement delay for an operation that had a particular event.

12. The method of claim 11, wherein the event is selected from a group consisting of a low-level cache miss, a secondary cache miss, a high-level cache miss, a cache access, a cache snoop, a branch misprediction, a fetch from memory, a lock at retirement, a hardware pre-fetch, a load, a store, a writeback, an instruction decode, an address translation, an access to a translation buffer, an integer operand execution, a floating point operand execution, a renaming of a register, a scheduling of an instruction, a register read, and a register write.

13. A method comprising:
tagging an operation upon occurrence of a particular event, the operation to be executed in a processor capable of parallel execution; and
determining a retirement pushout for the operation.

14. The method of claim 13, wherein the tagging of an operation comprises selecting the operation, upon the occurrence of the particular event, for sampling.

15. The method of claim 13, wherein the tagging of an operation comprises selecting the operation, upon the occurrence of the particular event and non-occurrence of a second event, for sampling.

16. The method of claim 14, wherein the particular event is selected from a group consisting of a cache miss, a cache access, a cache snoop, a branch misprediction, a lock at retirement, a hardware pre-fetch, a load, a store, a writeback, and access to a translation buffer.

17. The method of claim 14, wherein the particular event is a precise event based sampling at-retirement event.

18. The method of claim 14, wherein the determining a retirement pushout delay for the operation comprises:
initializing a first counter, upon selecting the operation for sampling;
determining the retirement pushout based on the initialization of the first counter and use of a storage register.

19. The method of claim 18, wherein the initialization of the first counter includes setting the first counter to a user defined value, and wherein use of a storage register includes, upon measuring the retirement pushout with the first counter, copying a state of the first counter into the storage register to be read out to determine the retirement pushout.

20. An apparatus comprising:
a microprocessor including:
a first module to determine a contribution of a microarchitectural feature for a user-level application; and
a second module to tune the microarchitectural feature based at least on the contribution of the microarchitectural feature, when the user-level application is to be executed.

21. The apparatus of claim 20, wherein determining a contribution of a microarchitectural feature for a user-level application comprises:
executing the user-level application with the microarchitectural feature enabled;
executing the user-level application with the microarchitectural feature disabled; and
determining the contribution of the microarchitectural feature for the user-level application based on comparing the execution of the user-level application with the feature enabled to the execution of the user-level application with the feature disabled.

22. The apparatus of claim 20, wherein tuning the microarchitectural feature comprises: changing the size of the microarchitectural feature, the microarchitectural feature being selected from a group consisting of an instruction cache, a data cache, a branch target array, a virtual memory table, and a register file.

23. The apparatus of claim 20, wherein tuning the microarchitectural feature comprises disabling the microarchitectural feature, the microarchitectural feature being selected from a group consisting of an instruction cache, a data cache, a translation table, a look-aside buffer, a branch prediction unit, a hardware prefetcher, and an execution unit.

24. The apparatus of claim 20, wherein tuning of the microarchitectural feature is further based on an amount of power consumed by the microarchitectural feature.

25. The apparatus of claim 23, wherein the second module comprises:
a register having a field associated with the microarchitectural feature, wherein the field, when set, is to disable the microarchitectural feature;
a module to set the field in the register associated with the microarchitectural feature, if the performance contribution of the feature, when disabled, is enhanced.

26. An apparatus comprising:
a microprocessor including,
a module to determine a per instance event cost for execution of a software program; and
a module to tune the software program based on the per instance event cost.

27. The apparatus of claim 26, wherein determining a per instance event cost comprises deriving the per instance event cost through a performance monitoring technique selected from a group consisting of duration counting, retirement pushout measurement, and long trace execution monitoring.

28. The apparatus of claim 26, wherein tuning the software program is selected from a group consisting of recompiling the software program, optimizing the software program, optimizing the software program to block data structures to fit within a cache, re-laying out the software program to take advantage of a default branch prediction condition, emitting code at a different instruction address, re-laying out data in dynamically-allocated memory, and adjusting the granularity and alignment of accesses.

29. A system comprising:
a controller hub coupled to a memory and to a video controller;
a microprocessor including a module to,
determine a per instance event contribution during execution of a software program;
tune an architectural configuration of the microprocessor based on the per instance event contribution;
store the architectural configuration; and
re-tune the architectural configuration based on the stored architectural configuration, upon subsequent execution of the software program.

30. The system of claim 29, wherein the microprocessor is capable of out-of-order parallel execution.

31. The system of claim 29, wherein the architectural configuration is stored in a register in the microprocessor.

32. The system of claim 29, wherein the determining a per instance event contribution during execution of a software program comprises:
measuring a plurality of retirement pushouts for a plurality of particular event occurrences, and
deriving the per instance event contribution for the particular event based on the plurality of retirement pushouts and the number of occurrences of the particular event.

33. The system of claim 29, wherein the determining a per instance event contribution during execution of a software program comprises:
executing the software program a plurality of times, wherein each time the software is executed:
the number of times a particular event occurs is changed, and
the performance of a critical path in the microprocessor is monitored;
deriving the per instance event contribution of the particular event based on comparing the change in performance of the critical path to the change in the number of times the particular event occurs.
